(19) United States
(12) Patent Application Publication
(10) Pub. No.: US 2009/0009607 A1
(43) Pub. Date: Jan. 8, 2009

(54) System for Providing Uniform Image Quality in Displays for Image Reproduction

(75) Inventor: Torben Dalgaard, Holstebro (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: BANG & OLUFSEN A/S, Struer (DK)

(21) Appl. No.: 11/996,702

(22) PCT Filed: Feb. 24, 2006
(86) PCT No.: PCT/DK06/00112

§ 371 Date: Jan. 24, 2008

(30) Foreign Application Priority Data
Feb. 24, 2005 (DK) PA 2005 00277

(51) Int. Cl. H04N 17/02

(52) U.S. Cl. 348/181; 348/E07.004

(57) ABSTRACT

Although video display screens are factory calibrated to correct performance, they differ in the actual color balance presented to the viewer. Similarly, the output of video sources may vary, in particular from video cameras. For recalibration purposes, each video display screen is connected to the video source via a Central Processing Device, and each video display screen is calibrated when first installed by means of a test signal having a pre-defined color balance. The signal is analyzed by means of a three-color sensor, and the information is fed back to the Central Processing Device and stored along with a device identifier. Any subsequent video signal provided to a particular video display screen will be modified electronically by means of individual stored parameters. Video sources will have their output signals similarly modified after having been subjected to a similar analysis performed on a video display screen already calibrated.

### BACKGROUND OF THE INVENTION

1. Field of the Invention

The present invention relates generally to methods for automatic adjustment of color balance on displays for image reproduction.

2. Description of Related Art

In a video system that comprises various discrete sources connected to a central video processing device, which drives one or more display(s), the color balance can vary from display to display and among the sources, especially if the output from the sources is RGB. The causes for such differences between displays may be both that the color balance is not calibrated in the display unit, but various sources may also transmit signals that are themselves not calibrated. One way to minimize the difference among displays and sources is to adjust each device manually in the actual setup. However, this only works for one source.

It is generally known that computer screens used for layout and composition of images in the graphics arts are calibrated by forcing the screen to display an image and to subject this image to color analysis by means of a complex sensor that is held against the screen. The observed analysis values are used for adjustments of the computer screen in order to obtain values within the tolerances defined for the work to be performed. However, this procedure must be performed for each screen that it is desired to use in a calibrated mode. The reference for the color rendition of the computer screen is dependent on the quality of the complex sensor.

Furthermore aging phenomena in the displays can alter the color balance over time. This means that calibration must be performed repeatedly.

### SUMMARY OF THE INVENTION

The present invention deals with these problems, by automatic adjustment of each device in the system.

According to the invention, each video display screen is connected to the video source via a Central Processing Device, and each video display screen is calibrated when first installed by means of a test signal having a pre-defined color balance. The signal is analyzed by means of a three-color sensor, and the information is fed back to the Central Processing Device and stored along with a device identifier. Any subsequent video signal provided to a particular video display screen will be modified electronically by means of individual stored parameters. Preferably these parameters are stored in the Central Processing Device. Video sources will have their output signals similarly modified by the Central Processing Device after having been subjected to a similar analysis performed on a video display screen already calibrated.

### BRIEF DESCRIPTION OF THE DRAWINGS

FIG. 1 shows a video system with three sources and two displays,

FIG. 2 is a black-and-white illustration of possible spread in white point due to tolerances in the chain,

FIG. 3 is a sketch of an exemplary setup for automated adjustment, and

FIG. 4 is a flow diagram of a display adjustment procedure.

### DETAILED DESCRIPTION OF THE INVENTION

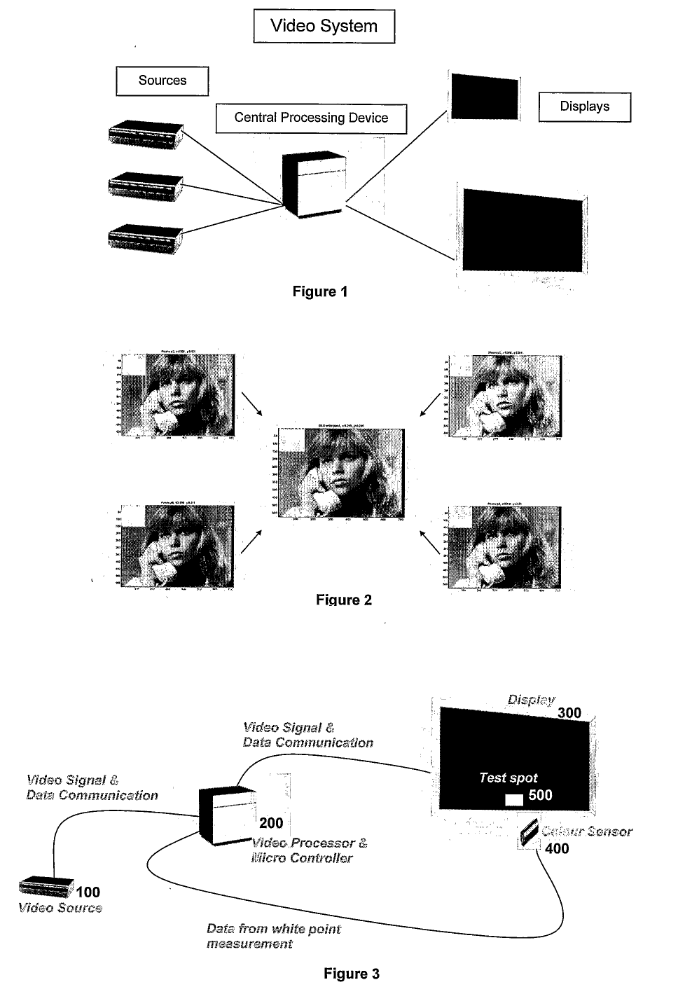

In FIG. 1 is shown a video system that may be part of a home entertainment arrangement. It comprises a number of video sources, such as a VCR, a DVD-player, a satellite receiver or the like. It also comprises a number of display units, which may be adapted to the viewing space, for instance a home cinema setup and smaller units for use in a kitchen or in a child's room. All of these are connected to a distributor containing a Central Processing Device (CPD) by means of cables or signal buses. It is frequently desirable to be able to watch a program, even though going to another room means that eye contact with the first display unit is replaced by eye contact to a different one, perhaps under different ambient light conditions. Under such circumstances, the difference in hue in various display units becomes very visible and annoying.

For obvious reasons, such differences are most visible in a color representation, but FIG. 2 shows a black-and-white representation of the effect of a change in white point caused by the accepted manufacturing tolerances.

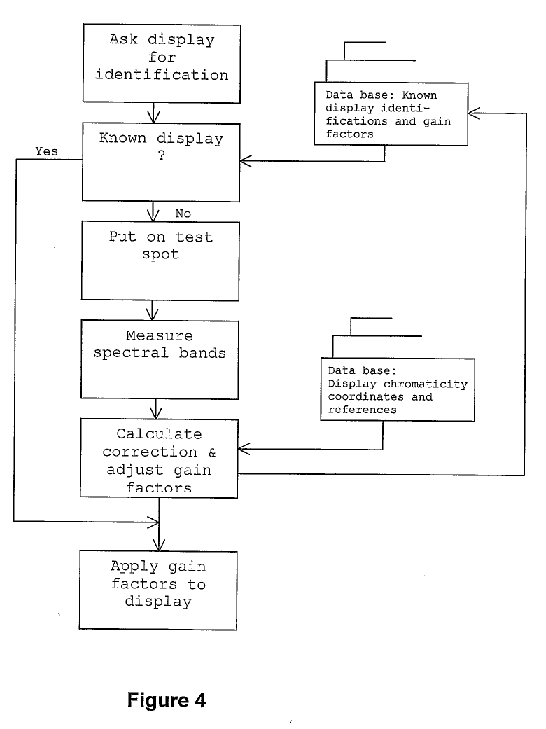

In FIG. 3 is shown the principle of the invention, comprising a video source 100, a distributor with a Central Processing Device 200, a video display unit 300 and a camera or color sensor 400 the output of which being transmitted to the Central Processing Device.

The setup works in the following manner: when a display (300) is connected to the Central Processing Device, CPD (200) an identifying communication takes place. Each device in the system has a unique identification code, and if the display is not recognized by the CPD, the CPD generates and sets up a test spot (500) on the display. The generated test spot can be a white spot, including all the display primaries, for example R, G and B (Red, Green and Blue), in a specific ratio, or it can be the display primaries applied in a sequence.

The test spot can be blanked by the CPD to allow measurement of ambient illumination. The Color Sensor (400) points at the spot and measures the amount of light in three spectral bands. All the measurement data are transmitted to and stored in the CPD, one measurement in each of the three spectral bands with the ‘spot on’ and one measurement in each spectral band with the ‘spot blanked’ (corresponds to ‘spot off’).

Before further processing the CPD subtracts, band by band, the measurements with the ‘spot blanked’ from the measurements with the ‘spot on’ to compensate for ambient illumination:

R_{display}=Rₛₚₒₜ_{_{—}}ₒₙ−Rₛₚₒₜ_{_{—}}_{off}

G_{display}=Gₛₚₒₜ_{_{—}}ₒₙ−Gₛₚₒₜ_{_{—}}_{off}

B_{display}=Bₛₚₒₜ_{_{—}}ₒₙ−Bₛₚₒₜ_{_{—}}_{off}

This information is stored in a table with an identifier for the corresponding display unit. Later, once the display has been identified, the chromaticity coordinates of the display primary colors can be identified among the pre-stored sets in the CPD. Using the chromaticity coordinates of the display primaries and the chromaticity coordinates of the spectral filters in the sensor (400) the amount of light from each primary is calculated by a linear transformation.

The resulting chromaticity coordinates, x, y and z, of the measured light can be found from the chromaticity coordinates of each spectral band, formed by the spectral filters, multiplied by the amplitude in each band represented by R, G, and B.

$$( \begin{matrix}xr & xg & xb \\ yr & yg & yb \\ zr & zg & zb\end{matrix} ) ( \begin{matrix}R \\ G \\ B\end{matrix} ) = ( \begin{matrix}x \\ y \\ z\end{matrix} ) \\ [ \begin{matrix} \\ M\end{matrix} ] = ( \begin{matrix}xr & xg & xb \\ yr & yg & yb \\ zr & zg & zb\end{matrix} )$$

$$( \begin{matrix}R 2 \\ G 2 \\ B 2\end{matrix} ) = {[ \begin{matrix} \\ M 2\end{matrix} ]}^{- 1} [ \begin{matrix} \\ M 1\end{matrix} ] ( \begin{matrix}R 1 \\ G 1 \\ B 1\end{matrix} )$$

If M2, R2, G2 and B2 relates to the display and M1, R1, G1 and B1 to the measurement, the amplitude of the display primaries, R2, G2 and B2, can be found as shown above.

If the ratios of these primaries do not match the pre-stored reference values for the specific display, the color balance is not right and a correction value for each primary is calculated.

The correction values are used to adjust the gain factors for the display primaries at the output, and the color balance is corrected in accordance. The new gain factors for the display primaries are stored in the CPD together with the identification code of the display. The display has now been calibrated to the Central Processing Device.

When an unknown video source (100) is connected to the CPD an identification procedure, similar to that described above, takes place between the CPD and the source. If the source is not recognized the CPD controls the source to generate and transmit a test spot (500). The quality of the test spot is no better than the pre-existing calibration of the video source. The CPD routes this test spot to the main display, which has already been calibrated. The camera (400) measures the color balance in the spot as described above. The CPD calculates correction values and adjusts the gain factors at the input for this source in accordance with the correction values. These gain factors are stored together with the identification code for the source.

In this way a set of output correction values are stored for each display and a set of input correction values for each source. The essential idea is that the camera or color sensor is in use, first for calibrating the video display monitor by means of a signal obtained from the Central Processing Device and subsequently for calibrating a video source with respect to the calibrated video display monitor.

It should be noted that the storage of parameters, such as gain factors, need not necessarily be stored in association with the Central Processing Device. Dependent on the data buses connected to the individual pieces of equipment, i.e. video display units and video sources, and their internal construction, such parameters may also be stored locally, to be called up by the Central Processing Device when needed.

In FIG. 4 is shown a flow diagram for the calibration procedure as it relates to a video display unit, and it summarizes the description given above.

In Plasma Displays the three phosphors degrade differently, and in Liquid Crystal Displays the backlight and color filters can cause a shift in color balance over time. In order to counteract this, at certain time intervals a calibration procedure may be initiated automatically to compensate for aging phenomena in displays. Similarly, the electronics in the sources may age, and calibration on a regular basis or after a long period of non-use may be automatically instituted according to the invention.

Possibly a calibration procedure can also be initiated from the remote control, or by pressing a button on the device itself.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

Thus, the expressions “means to . . . ” and “means for . . . ”, or any method step language, as may be found in the specification above and/or in the claims below, followed by a functional statement, are intended to define and cover whatever structural, physical, chemical, or electrical element or structure, or whatever method step, which may now or in the future exist which carries out the recited functions, whether or not precisely equivalent to the embodiment or embodiments disclosed in the specification above, i.e., other means or steps for carrying out the same function can be used; and it is intended that such expressions be given their broadest interpretation.

1. A method for providing calibrated image information on a video display screen that is connected to a distributor of video information, comprising providing a test image on the screen and using a measurement on said image to control the electric signal to the screen, wherein, in a first mode of operation, the screen is supplied from a Central Processing Device provided in the distributor of video information with a test signal having a pre-defined colour balance, said test signal being read in image form from the screen by means of a three-colour sensor, the output of said sensor being fed back to the Central Processing Device in order to change the colour balance of the test signal so that the image is measured to fulfil pre-determined criteria for colour balance, and storing a set of parameters necessary to obtain the calibrated image, and that in a second mode of operation programme video material is supplied to the video display screen from the distributor of video information after having been modified by the stored parameters.

2. A method according to claim 1, wherein the video display screen is one of a number that may be connected to the Central Processing Device, each screen being represented by a set of parameters, and that the individual parameters relating to a particular screen are utilized for modifying the electric signal to said particular screen when it is used for display in the second mode of operation.

3. A method according to claim 1 wherein the set of parameters for a particular video display screen is stored in storage means associated with the Central Processing Device.

4. A method according to claim 1, wherein the set of parameters for a particular video display screen is stored in means associated with the particular video display screen.

5. A method according to claim 3, wherein each video display screen identifies itself uniquely to the Central Processing Device in order that the appropriate set of parameters may be applied to the electric signals transmitted to the video display screen in the second mode of operation.

6. A method according to claim 1, wherein the test signal is composed of two subsequent signals, the first being a blanking signal to permit registration of the ambient illumination on the display screen by means of the three-colour sensor, the second being the signal having the pre-defined colour balance, a subtraction of the image information being performed in the Central Processing Device.

7. A method according to claim 1 used for the subsequent calibration of a video source, wherein the video source is set to generate a test signal as closely as possible approximating a pre-defined colour balance, that the signal is passed via the Central Processing Device to a video display screen that has already been calibrated and for which calibration data are stored, the image of said video source signal being subjected to measurement according to the first mode of operation, the result of said measurement being fed back to the Central Processing Device in order to change the colour balance of the test signal so that the image is measured to fulfil pre-determined criteria for colour balance, and that the set of parameters relating to the particular video source is stored for modifying the video source signal whenever said video source is used as the provider of video information in the second mode of operation.

8. A method according to claim 7, wherein the set of parameters for a particular video source is stored in storage means associated with the Central Processing Device.

9. A method according to claim 7, wherein the set of parameters for a particular video source is stored in storage means associated with said video source.

10. A method according to claim 1, wherein the first mode of operation is instituted for a particular video source or video display monitor on a regular basis or after a long period of disuse of the particular video source of video display monitor, and that revised sets of parameters are stored.

11. An apparatus for performing the method according to claim 1,
wherein the apparatus comprises
a supplier of two kinds of image signals,
an image calibration first signal representing a calibration image that has a pre-defined colour balance in a pre-defined sub-area of the image for a first mode of operation, and
a utility second image signal for a second mode of operation,
a monitor for displaying said signals,
a camera as a three-colour sensor for observing said sub-area of the image, generating a reference signal
a signal path for transmitting said reference signal to the supplier of signals
means for storing said reference signal as chromaticity and intensity information in a table
means for using said table information to modify any incoming signals having a correct colour balance in order to obtain a utility signal that is modified to obtain a correct colour balance on the monitor when displaying an intended programme.

12. An apparatus according to claim 11, wherein the camera is fitted on a mechanism that in the calibration mode extends an arm and provides proper placement with respect to the sub-area of the image and in the programme display mode provides retraction and storage.
